(19) United States
(12) Patent Application Publication
(10) Pub. No.: US 2011/0309081 A1
(43) Pub. Date: Dec. 22, 2011

(54) DRUM BAND ASSEMBLY

(75) Inventors: Robert J. Starr, Tyrone, PA (US); R. Douglas Evans, JR., Everett, PA (US)

(73) Assignee: NEW PIG CORPORATION, TIPTON, PA (US)

(21) Appl. No.: 12/967,194

(22) Filed: Dec. 14, 2010

Related U.S. Application Data
(60) Provisional application No. 61/286,867, filed on Dec. 16, 2009.

(51) Int. Cl. B65D 45/34; E05C 19/00

(52) U.S. Cl. 220/321; 292/299

(57) ABSTRACT

A drum band assembly for securing a lid to a drum. The drum band assembly includes a band having a first free end and a second free end, means for removably attaching the band to the drum and means for attaching the lid to the band. The band and the means for removably attaching the band to the drum are structured and arranged to provide for the drum band assembly to fit a drum having varying diameters or a drum of varying volumes, e.g. 55 gallon or 30 gallon drums.

### CROSS REFERENCE TO RELATED APPLICATION

This application claims the benefit of U.S. Provisional Patent Application Ser. No. 61/286,867 filed Dec. 16, 2009, which is fully incorporated herein by reference.

### BACKGROUND OF THE INVENTION

The invention relates generally to a drum band assembly.

Drums used in the waste industry to contain and store potentially hazardous wastes, such as waste oils, or to store other materials are typically 55 gallon or 30 gallon drums, but can also range, for example, from 85 gallon to 5 gallon drums. Two general types of containers are common in the hazardous waste industry. These two types are open head containers and closed head containers. Closed head containers have a nonremovable top with a relatively small opening in that top. Waste materials are able to be entered into the container through the small opening, usually through the use of some type of funnel. Open head containers are containers in which the cover is substantially the same width as the drum and may be attached and detached from the container.

Open head containers utilize a flat cover which mates to the drum. Unsealed lids can be used which sit on a drum and are thus easily removed. Such unsealed lids carry the risk that hazardous material will exit the drum. Thus, the industry utilizes covers for open head containers which may be sealably secured to the drum.

Sealably securing the cover to the drum is necessary because certain potentially hazardous wastes may be placed in sealed containers. For example, volatile organic compounds must often be placed in the containers. Thus, the waste container must have a top which can be sealed to the drum in order to prevent the volatile organic compounds from exiting the container and entering the environment. Typically, the cover is secured to the drum by means of a bolt ring. In operation, the bolt ring is placed around the cover and the drum. Then, bolts are engaged with the bolt ring so as to tighten down the bolt ring around the cover and the drum.

In addition to being sealable, the cover must be removable, because materials often must be added to the drums at incremental stages. With covers currently available for use with open head containers, it is difficult to know if a proper seal has been attained. In an effort to make the sealing of the drum easier, mechanical devices have been employed, which press the bolt ring to the drum. The more often a cover is removed and resecured to a drum, the more likely that an improper seal will exist between the cover and the drum. In any event, removing the entire cover and resecuring it with a bolt ring is relatively time consuming.

In addition, because drums come in varying sizes, e.g. 55 gallon or 30 gallon drums most bolt ring configurations are made to fit one size drum and are, therefore, not adaptable to fit different size drums. In addition, drums that have been used are regularly reconditioned for reuse. The process of reconditioning usually will change the diameter of the opening compared to the new drum. Reconditioned drum use has grown substantially and as a result a large percentage of drums used in industry are reconditioned. Reconditioned drums of the same capacity can therefore have widely varying diameters.

Therefore, it would be advantageous to provide a cover that may be sealed to the waste container and remain sealed throughout the period in which materials are added to the drum. It would be further advantageous for such a drum to be capable of being opened and closed easily so as to allow materials to be added to the drum when necessary. It would also be advantageous for the assembly that secures the lid to the drum to be adaptable to fit drums of varying diameters.

### SUMMARY OF THE INVENTION

An aspect of the invention includes a drum band assembly for securing a lid to a drum. The drum band assembly includes a band having a first free end and a second free end, means for removably attaching the band to the drum and means for attaching the lid to the band. The band and the means for removably attaching the band to the drum are structured and arranged to provide for the drum band assembly to fit a drum having varying diameters or a drum of varying volumes, e.g. 55 gallon or 30 gallon drums.

Another aspect of the invention includes an apparatus having a drum, a drum lid and a drum band assembly for securing the drum lid to the drum. The drum band assembly includes a band having a first free end and a second free end, means for removably attaching the band to the drum and means for attaching the drum lid to the band.

These and other aspects of the present invention will be more fully understood following a review of this specification and drawings.

### BRIEF DESCRIPTION OF THE DRAWINGS

FIG. 1 illustrates an isometric view of a drum band assembly, in accordance with an aspect of the invention.

FIG. 2 illustrates a top isometric view of the drum band assembly of FIG. 1 as mounted on a drum, in accordance with an aspect of the invention.

FIG. 3 illustrates a top view of the drum band assembly of FIG. 1 as mounted on a drum, in accordance with an aspect of the invention.

FIG. 4 illustrates an isometric view of the drum band assembly of FIG. 1 as mounted on a drum, in accordance with an aspect of the invention.

FIG. 5 is an enlarged, partial view of the drum band assembly of FIG. 1 as mounted on a drum, in accordance with an aspect of the invention.

FIG. 6 is side view of the drum band assembly of FIG. 1 as mounted on a drum, in accordance with an aspect of the invention.

FIG. 7 is an isometric view of the drum band assembly of FIG. 1 as mounted on a drum, in accordance with an aspect of the invention.

### DETAILED DESCRIPTION

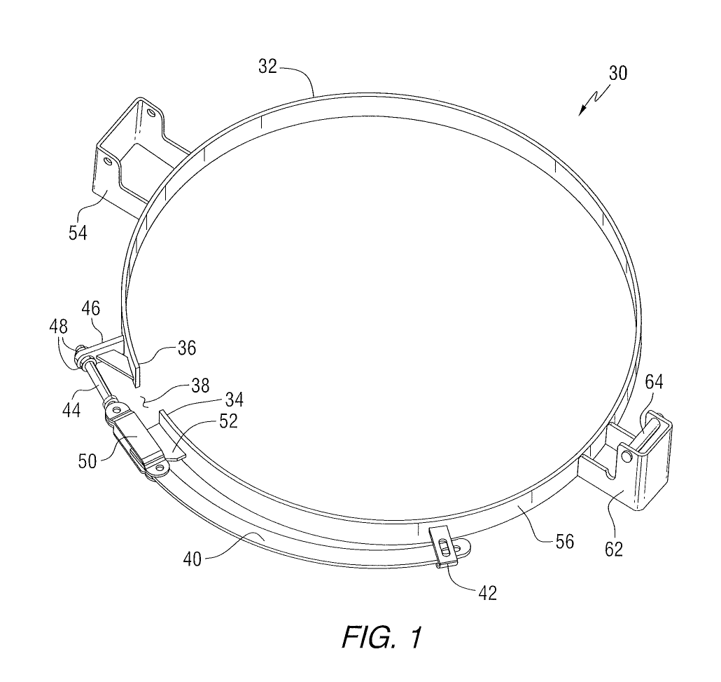

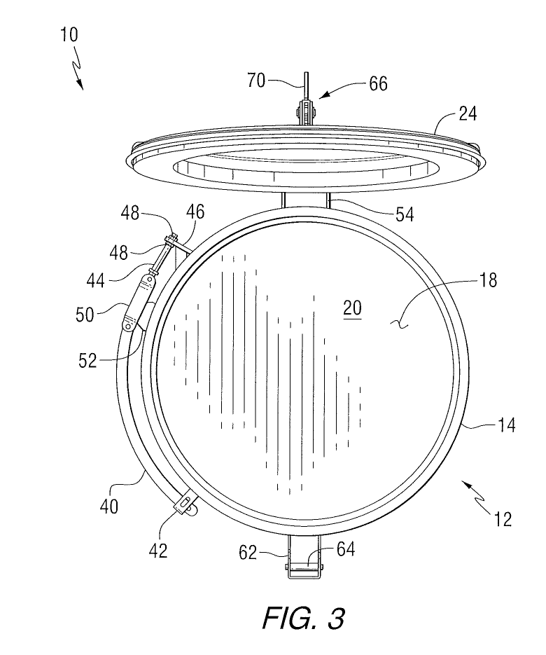

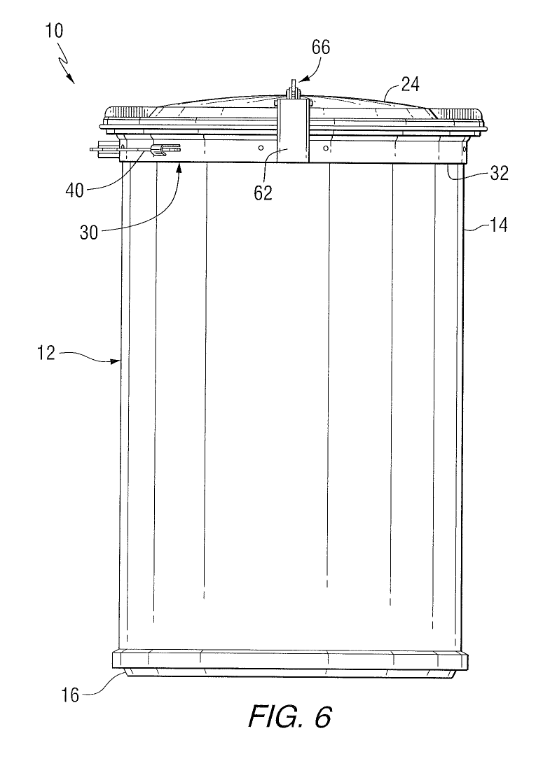

Referring to FIGS. 1-7, there is illustrated a container or drum assembly 10, in accordance with an aspect of the invention. The drum assembly 10 includes a drum 12 that may be used for storing any type of material such as, but not limited to, potentially hazardous waste materials or waste oils. The drum 12 includes a top 14 and a bottom 16. The top 14 includes an open end 18. The bottom 16 includes a closed end 20. A sidewall 22 extends generally between the top 14 and the bottom 16, e.g., the sidewall 22 extends between the open end 18 and the closed end 20. The drum 12 may be any desired size such as, for example, a 55 gallon drum or a 30 gallon drum, but can also range, for example, from 85 gallon to 5 gallon drums. The drum 12 may be made of any suitable material depending upon the particular type of waste or storage material to be contained therein.

The drum assembly 10 further includes a drum lid 24 for generally covering the open end 18 of the drum 12. In one aspect of the invention, the drum lid 24 may be sealably secured to the open end 18 of the drum 12 and may be attached and detached from the drum 12.

The drum assembly 10 further includes a drum band assembly 30 for removably securing the drum lid 24 to the drum 12. In one aspect, the drum band assembly 30 is positioned on the drum 12 adjacent to the top 14, e.g., adjacent to the open end 18 of the drum 12. As will be appreciated from the description and drawings set forth herein, the drum band assembly 30 is structured and arranged to provide for the drum band assembly 30 to fit a drum having various sizes or diameters. For example, the drum 12 may be a 55 gallon or a 30 gallon drum but other size drums may be used in association with the invention as well.

The drum band assembly 30 includes a band 32 which may be, for example, a flat metal band for circumferentially disposing the sidewall 22 of the drum 12 adjacent to the top 14 and open end 18. The band 32 of the drum band assembly 30 includes a first free end 34 at one end thereof and a second free end 36 at another end thereof. The first free end 34 and the second free end 36 define an open space 38 therebetween. The open space 38 in association with the band 32 being formed of a generally flexible material allows for the band 32 to be positioned on the described drums of varying sizes or diameters.

In accordance with an aspect of the invention, the drum band assembly 30 includes means for removably attaching the band 32 to the drum 12. This may include, for example, a lever arm 40 that is pivotally connected to the first free end 34 of the band 32. In one aspect, the lever arm 40 is connected to the first free end 34 by means of an additional extension bracket 52. This provides for the lever arm 40 to be pivotally connected to the first free end 34 of the drum 32.

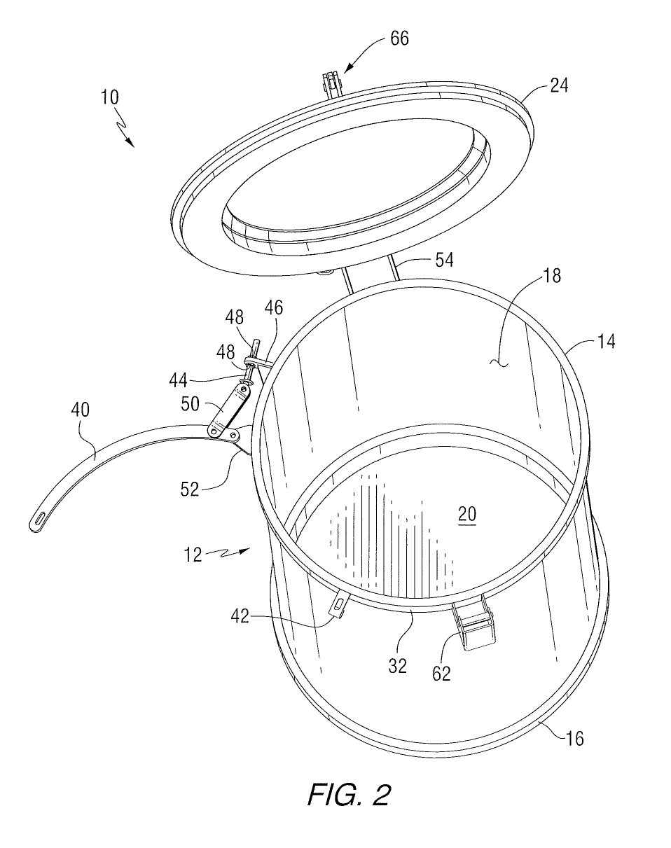

The lever arm 40 is movable between a closed position (see, for example, FIG. 1) and an open position (see, for example, FIG. 2). When in the closed position, the lever arm 40 may be secured in place by a bracket 42 that is attached to the periphery of the band 32 of the drum band assembly 30. The lever arm 40 is removably attached to the bracket 42 for opening and closing the lever arm as desired. As can be appreciated, when the drum band assembly 30 has the lever arm 40 in an open position, the drum band assembly 30 may be placed on the drum 12 or removed from the drum 12 as desired.

Once the drum band assembly 30 is positioned in the appropriate location on the drum 12, the means for removably attaching the band 32 to the drum 12 further includes a size adjusting linking mechanism. In one aspect, the size adjusting linking mechanism is connected to the second free end 36 of the band 32 and to the lever arm 40. More specifically, in one aspect the size adjusting linking mechanism includes a bolt 44 that is threadably secured to an extension 46 of the second free end 36 of the band 32. A pair of nuts 48 are provided on the bolt 44 and positioned on opposing sides of the extension 46. An opposing end of the bolt 44 is connected to a connector arm 50 which, in turn, is pivotally connected to the lever arm 40.

In operation, the drum band assembly in an open position is placed on the drum 12 and positioned adjacent to the top 14, e.g., open end 18 of the drum 12. Once in the desired position, the lever 40 is actuated to evaluate if a secure fastening can be achieved. If adjustments are needed the nuts 48 are manipulated to adjust the opening and closing diameter of the band so that once the lever arm is actuated to the closed position it will provide a secure fastening of the band 32 to the outer periphery of the drum 12.

In order to remove the drum band assembly 30 from the drum 12, the reverse operation as described above for attaching the drum band assembly is performed.

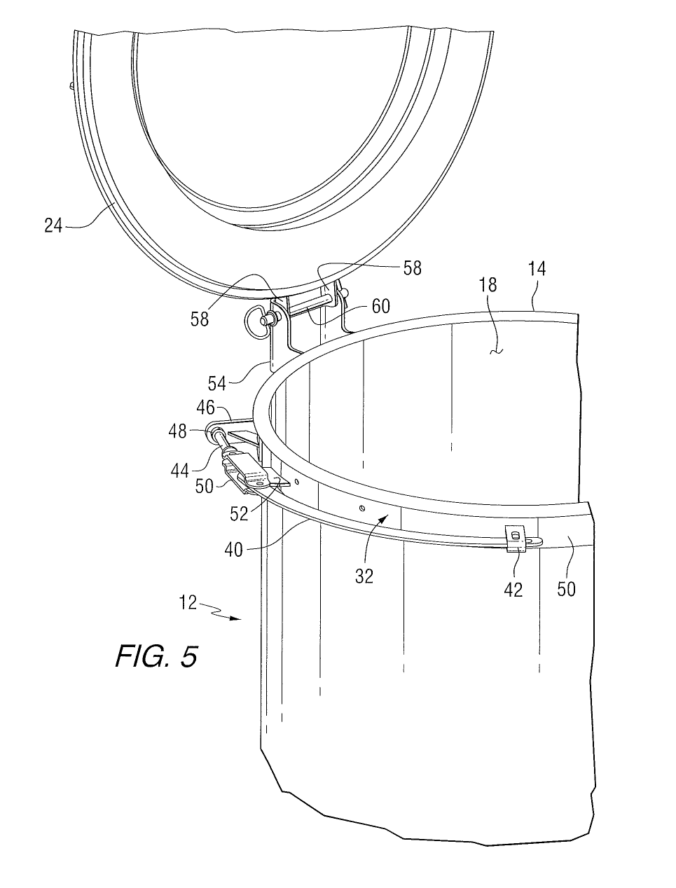

The drum band assembly 30 further includes means for attaching the lid 24 to the band 32. In one aspect,. this means for attaching the drum lid 24 to the band 32 may include a lid mounting bracket 54 that is attached to a periphery of the band 32. More specifically, the lid mounting bracket 54 is attached to an outer periphery 56 of the band 32. The lid 24 includes mounting brackets 58 that may be pivotally and removably secured to the lid mounting bracket 54 by, for example, a pin 60 that is removably secured to the lid mounting bracket 54 and the mounting brackets 58 of the lid 24 (see, for example, FIG. 5). It will be appreciated that other means for removably attaching the drum lid 24 to the band 32 may be provided in accordance with aspects of the invention.

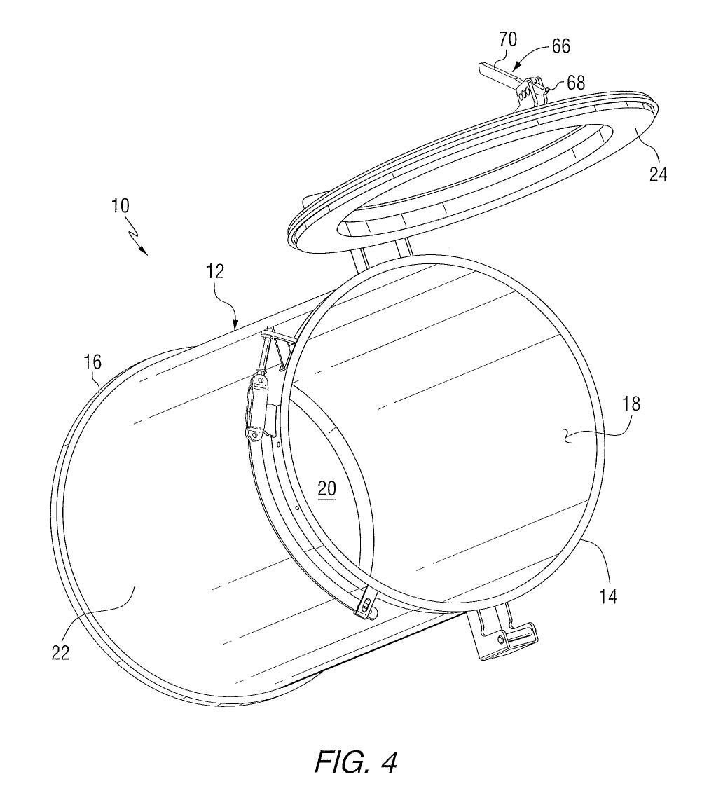

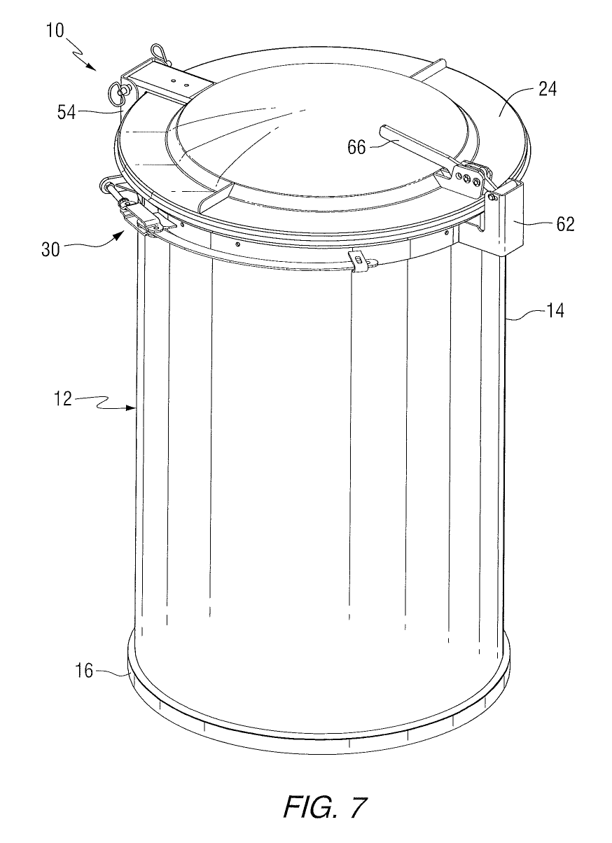

The drum band assembly 30 further includes means for latching the drum lid 24 to the band 32. In one aspect, the means for latching the drum lid 24 to the band 32 may include a latching bracket 62. In one aspect, the latching bracket 62 is mounted on the outer periphery 56 of the band 32 and positioned generally opposite to the lid mounting bracket 54. In one aspect, the latching bracket 62 includes a latching pin 64 for cooperating with a latching handle assembly 66 that may be mounted to the lid 24. The latching handle assembly is pivotally connected to the lid 24 and includes a first end 68 and a handle end 70 that is structured and arranged for cooperating with the latching pin 64 of the latching bracket between an unsecured position (see, for example, FIG. 4) and a secured or latched position (see, for example, FIG. 7). Thus, it will be appreciated that this allows for the drum lid 24 to be latched and unlatched to the drum 12 so as to provide for placement of the desired materials into the drum 12 and for removing the materials from the drum 12 as needed.

Whereas particular embodiments of this invention have been described above for purposes of illustration, it will be evident to those skilled in the art that numerous variations of the details of the present invention may be made without departing from the invention as defined in the appended claims.

What is claimed is:

1. A drum band assembly for securing a lid to a drum, comprising:
a band having a first free end and a second free end;
means for removably attaching the band to the drum; and
means for attaching the lid to the band.

2. The drum band assembly of claim 1, further comprising means for latching the lid to the band.

3. The drum band assembly of claim 1, wherein the means for removably attaching the band to the drum includes a lever arm.

4. The drum band assembly of claim 3, wherein the lever arm is pivotally connected to the first free end of the band.

5. The drum band assembly of claim 4, wherein the means for removably attaching the band to the drum further includes a size adjusting linking mechanism.

6. The drum band assembly of claim 5, wherein the size adjusting linking mechanism is connected to the second free end of the band and to the lever arm.

7. The drum band assembly of claim 1, wherein the band and the means for removably attaching the band to the drum are structured and arranged to provide for the drum band assembly to fit a drum having varying diameters.

8. The drum band assembly of claim 2, wherein the means for attaching the lid to the band includes a lid mounting bracket attached to a periphery of the band.

9. The drum band assembly of claim 8, wherein the means for latching the lid to the band includes a latching bracket attached to the periphery of the band generally opposite the lid mounting bracket.

10. An apparatus, comprising:
a drum having an open end, a closed end and a sidewall extending therebetween;
a drum lid for covering the open end of the drum; and
a drum band assembly for removably securing the drum lid to the drum, the drum band assembly comprising:
a band having a first free end and a second free end;
means for removably attaching the band to the drum; and
means for attaching the lid to the band.

11. The apparatus of claim 10, further comprising means for latching the drum lid to the band.

12. The apparatus of claim 10, wherein the means for removably attaching the band to the drum includes a lever arm.

13. The apparatus of claim 12, wherein the lever arm is pivotally connected to the first free end of the band.

14. The apparatus of claim 13, wherein the means for removably attaching the band to the drum further includes a size adjusting linking mechanism.

15. The apparatus of claim 14, wherein the size adjusting linking mechanism is connected to the second free end of the band and to the lever arm.

16. The apparatus of claim 10, wherein the band and the means for removably attaching the band to the drum are structured and arranged to provide for the drum band assembly to fit a drum having varying diameters.

17. The apparatus of claim 11, wherein the means for attaching the drum lid to the band includes a lid mounting bracket attached to a periphery of the band.

18. The apparatus of claim 17, wherein the means for latching the drum lid to the band includes a latching bracket attached to the periphery of the band generally opposite the lid mounting bracket.

19. The apparatus of claim 10, wherein a volume of the drum is in the range of eighty five gallons to five gallons.

20. The apparatus of claim 10, wherein the drum band assembly is positioned adjacent the open end of the drum.
